(19) United States
(12) Patent Application Publication
(10) Pub. No.: US 2025/0261147 A1
(43) Pub. Date: Aug. 14, 2025

(54) ABORTING AND INDICATING FAILURE OF PROPAGATION DELAY COMPENSATION MEASUREMENT IN SPLIT NETWORK NODE ARCHITECTURE

(71) Applicant: Telefonaktiebolaget LM Ericsson (publ), Stockholm (SE)

(72) Inventors: Nianshan SHI, Järfälla (SE); Yazid LYAZIDI, Hässelby (SE); Zhenhua ZOU, Solna (SE)

(21) Appl. No.: 18/858,228

(22) PCT Filed: Mar. 24, 2023
(86) PCT No.: PCT/IB2023/052944

§ 371 Date: Oct. 18, 2024

Related U.S. Application Data
(60) Provisional application No. 63/333,901, filed on Apr. 22, 2022.

(51) Int. Cl. H04W 56/00; H04W 36/00

(52) U.S. Cl. CPC H04W 56/0045; H04W 36/0058

(57) ABSTRACT

A method, system and apparatus are disclosed. According to some embodiments, a central unit, CU, associated with a network node that is configured to communicate with a wireless device is provided. The CU is configured to transmit a first message to a distributed unit, DU, associated with the network node where the first message requests for the DU to at least one of pause and terminate at least one on-going Propagation Delay Compensation, PDC, measurement, and receive a second message from the DU, the second message indicating failure of at least one PDC measurement during a periodic reporting period for PDC measurements.

### FIELD

The present disclosure relates to network communications, and in particular, to functionality associated with Propagation Delay Compensation (PDC) measurements.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### Propagation Delay Compensation (PDC) to Achieve Very Accurate Reference Time Delivery

In an industrial use case where the provision of industrial clock synchronization service is supported through the 5G system, the 5G system is in practice only allowed to contribute a portion of the maximum end-to-end synchronicity budget (uncertainty budget) allowed for any given Time-Sensitive Network (TSN) Grandmaster clock. There are many uncertainty components in the 5G system, including the wireless device internal synchronization error budget, and the synchronization error budget associated with delivering the 5G internal clock to the user plane function (UPF) and the wireless device.

One 5GS synchronization error (e.g., biggest synchronization error) introduced is when the 5G internal clock is delivered to a wireless device from the network node (e.g., gNB) via the Uu interface. This error occurs on the air interface and is due to the error from unknown propagation delays. In some large cells, the propagation delay from the network node to the wireless device can be 1 μs or larger (i.e., the distance from the network node to the wireless device is 300 meters or more). The range of uncertainty for the most demanding synchronization requirement for a single Uu interface shown in Table 1 below was agreed at 3GPP TSG-RAN WG2 #113-e to meet performance requirements. Two scenarios are listed to represent a general wide area deployment and a local deployment area.

TABLE 1
Time synchronization error budget for single Uu interface

| Scenario | Single Uu interface Budget |
|---|---|
| Control-to-Control | ±145 ns to ±275 ns |
| Smart Grid | ±795 ns to ±845 ns |

In 3GPP Release 15 (Rel-15)/Release 16 (Rel-16), the legacy uplink (UL) transmission timing adjustment (i.e., timing advanced, TA) can be re-used to estimate and compensate the propagation delay. 3GPP Timing Advance (TA) command is utilized in cellular communication for uplink transmission synchronization and it is an implementation variant of a Round Trip Time (RTT) measurement. Theoretically, the dynamic part of the TA, i.e., NTA is equal to (2×propagation delay) considering the same propagation delay value applies to both downlink and uplink directions. Since the TA command is transmitted to the wireless device via, for example, the MAC control element (CE), the wireless device can derive the propagation delay. The challenges of the TA method are that due to various implementation inaccuracies in transmit timing and reception timing at network node and wireless device, these inaccuracies may introduce up-to 540 ns of uncertainty in determining the downlink propagation delay on a single Uu interface based on Rel-15/Rel-16 implementation requirements. Nevertheless, TA-based propagation delay compensation may meet the requirement for the smart grid scenario in Table 1.

In the 3GPP discussion, it has been discussed in the RAN1 #107e meeting that the legacy TA-based mechanism is supported. In the RAN2 #115e meeting, it is discussed that RAN2 assumes the network node can perform pre-compensation in the case of legacy-TA based mechanism. For example, if the network node indicates to the wireless device not to compensate based on the legacy-TA PDC, then the assumption is that the network node may have pre-compensated the propagation delay.

### CU-DU Split and Reference Time Delivery

In the network node split architecture, the gNB-CU (e.g., CU associated with a network node) receives information over NG Application Protocol (NGAP) on the N2interface. The System Information Blocks (SIBs) are distributed to the gNB-DU over F1AP on the F1 interface, and the gNB-DU handles the scheduling and transmission to the Uu interface. FIG. 1 is a diagram of the network node split architecture.

### Signaling of Timing Advance in 3GPP TS 38.473 (e.g., 38.473 v17.0.0)

In the context of PDC, NR TADV has been introduced in F1 protocol between the gNB-CU and gNB-DU. The reporting of the NR TADV (e.g., timing advance) by the gNB-DU is a consequence of the initial request coming from the positioning server to the NG-Radio Access Network N (RAN). A description of 3GPP TS 38.473 of the defined procedures and messages is provided below:

### PDC Measurement Reporting Messages

### PDC Measurement Initiation Request

This message is sent by gNB-CU to initiate PDC measurements. Direction: gNB-CU to gNB-DU.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message Type | M | | 9.3.1.1 | YES | reject |
| gNB-CU UE | M | | 9.3.1.4 | YES | reject |
| F1AP ID | | | | | |
| gNB-DU UE | M | | 9.3.1.5 | YES | reject |
| F1AP ID | | | | | |
| RAN UE | M | | INTEGER | YES | reject |
| PDC | | | (1 . . . 16, | | |
| Measurement | | | . . . ) | | |
| ID | | | | | |
| PDC Report | M | | ENUMERATED | YES | reject |
| Type | | | (OnDemand, | | |
| | | | Periodic, . . . ) | | |
| PDC | C- | | ENUMERATED | YES | reject |
| Measurement | ifReportTypePeriodic | | (120 ms, 240 ms, | | |
| Periodicity | | | 480 ms, 640 ms, | | |
| | | | 1024 ms, | | |
| | | | 2048 ms, | | |
| | | | 5120 ms, | | |
| | | | 10240 ms, | | |
| | | | 20480 ms, | | |
| | | | 40960 ms, | | |
| | | | 1 min, 6 min, | | |
| | | | 12 min, 30 min, | | |
| | | | . . . ) | | |
| PDC | | 1 . . . | | EACH | reject |
| Measurement | | <maxnoMeasPDC> | | | |
| Quantities | | | | | |
| >PDC | M | | ENUMERATED | — | |
| Measurement | | | (NR PDC | | |
| Quantities | | | TADV, gNB | | |
| Item | | | RX-TX, | | |
| | | | . . . ) | | |

| Range bound | Explanation |
|---|---|
| maxnoMeasPDC | Maximum no. of PDC measured |
| | quantities that can be configured |
| | and reported with one message. |
| | Value is 16. Maximum is 1 in this |
| | release. |

| Condition | Explanation |
|---|---|
| ifReportTypePeriodic | This IE shall be present if the |
| | PDC Report Type IE is set to the |
| | value “Periodic”. |

### PDC Measurement Initiation Response

This message is sent by gNB-DU to indicate that the requested PDC measurement is successfully initiated.

Direction: gNB-DU to gNB-CU.

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | reject |
| gNB-CU UE | M | 9.3.1.4 | YES | reject |
| F1AP ID | | | | |
| gNB-DU UE | M | 9.3.1.5 | YES | reject |
| F1AP ID | | | | |
| RAN UE PDC | M | INTEGER | YES | reject |
| Measurement ID | | (1 . . . 16, . . . ) | | |
| PDC Measurement | O | 9.3.1.232 | YES | ignore |
| Result | | | | |
| Criticality | O | 9.3.1.3 | YES | ignore |
| Diagnostics | | | | |

### PDC MEASUREMENT INITIATION FAILURE

This message is sent by gNB-DU to indicate that the requested PDC measurement cannot be initiated.

Direction: gNB-DU to gNB-CU.

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | ignore |
| gNB-CU UE | M | 9.3.1.4 | YES | reject |
| F1AP ID | | | | |
| gNB-DU UE | M | 9.3.1.5 | YES | reject |
| F1AP ID | | | | |
| RAN UE PDC | M | INTEGER | YES | reject |
| Measurement | | (1 . . . 16, . . . ) | | |
| ID | | | | |
| PDC Measurement | M | 9.3.1.232 | YES | ignore |
| Result | | | | |
| Message Type | M | 9.3.1.1 | YES | reject |
| gNB-CU UE | M | 9.3.1.4 | YES | reject |
| F1AP ID | | | | |
| gNB-DU UE | M | 9.3.1.5 | YES | reject |
| F1AP ID | | | | |
| Cause | M | 9.3.1.2 | YES | ignore |
| Criticality | O | 9.3.1.3 | YES | ignore |
| Diagnostics | | | | |

### PDC MEASUREMENT REPORT

This message is sent by gNB-DU to report the results of the requested PDC measurement.

Direction: gNB-DU to gNB-CU.

When the service is released, due to, e.g., QoS flow release, the wireless device may still have other services, i.e., the connection is still kept. However, the gNB-CU may not be able to inform the gNB-DU about certain situations such as to stop related PDC measurements or to indicate gNB-CU failure during periodically reporting.

### SUMMARY

Some embodiments advantageously provide methods, systems, and apparatuses associated with functionality associated with Propagation Delay Compensation (PDC) measurements.

The gNB-CU can abort or force to terminate on-going measurement for PDC due to release of service (i.e., release of QoS flow) and liberate resources at gNB-DU.

The gNB-DU can indicate, in case of periodic measurement reporting for TA-PDC that the resources can no longer be reported due to shortage of resources, radio conditions changes, or other causes.

According to one aspect of the present disclosure, a central unit, CU, 34 associated with a network node that is configured to communicate with a wireless device is provided. The CU includes processing circuitry. The processing circuitry is configured to transmit a first message to a distributed unit (DU) associated with the network node, the first message requesting for the DU to at least one of pause and terminate at least one on-going Propagation Delay Compensation (PDC) measurement. The processing circuitry is configured to receive a second message from the DU, the second message indicating failure of at least one PDC measurement during a periodic reporting period for PDC measurements.

According to one or more embodiments of this aspect, at least one of the first message and second message is communicated using wireless-device-associated signaling.

According to one or more embodiments of this aspect, at least one of the first message and second message is a F1 application protocol, F1AP, procedure.

According to one or more embodiments of this aspect, the first message includes a Radio Access Network (RAN) wireless device PDC Measurement identifier (ID) to allow the DU to differentiate parallel procedures on-going over F1AP for a PDC measurement.

According to one or more embodiments of this aspect, the second message indicates a reason for the failure.

According to one or more embodiments of this aspect, the processing circuitry is further configured to determine whether the at least one on-going PDC measurement has been at least one of paused and terminated by the DU based on the second message.

According to one or more embodiments of this aspect, the processing circuitry is further configured to trigger the DU to release resources the DU has allocated for the at least one on-going PDC measurement.

According to one aspect of the present disclosure, a method implemented in a central unit (CU) associated with a network node that is configured to communicate with a wireless device is provided. The method includes transmitting a first message to a DU with the network node, the first message requesting for the DU to at least one of pause and terminate at least one on-going PDC measurement. The method includes receiving a second message from the DU, the second message indicating failure of at least one PDC measurement during a periodic reporting period for PDC measurements.

According to one or more embodiments of this aspect, at least one of the first message and second message is communicated using wireless-device-associated signaling.

According to one or more embodiments of this aspect, at least one of the first message and second message is a F1AP procedure.

According to one or more embodiments of this aspect, the first message includes a RAN wireless device PDC Measurement ID to allow the DU to differentiate parallel procedures on-going over F1AP for a PDC measurement.

According to one or more embodiments of this aspect, the second message indicates a reason for the failure.

According to one or more embodiments of this aspect, the method further includes determining whether the at least one on-going PDC measurement has been at least one of paused and terminated by the DU based on the second message.

According to one or more embodiments of this aspect, the method further includes
triggering the DU to release resources the DU has allocated for the at least one on-going PDC measurement.

According to one aspect of the present disclosure, a DU associated with a network node that is configured to communicate with a wireless device is provided. The DU includes processing circuitry. The processing circuitry is configured to receive a first message from a CU associated with the network node, the first message requesting for the DU to at least one of pause and terminate at least one on-going PDC measurement. The processing circuitry is configured to transmit a second message to the CU, the second message indicating failure of at least one PDC measurement during a periodic reporting period for PDC measurements.

According to one or more embodiments of this aspect, the processing circuitry is further configured to at least one of pause and terminate the at least one on-going PDC measurement and release at least one resource allocated to the at least one on-going PDC measurement based on the first message.

According to one or more embodiments of this aspect, the processing circuitry is further configured to attempt to identify the at least one on-going PDC measurement; and ignore the first message if the at least one on-going PDC measurement indicated in the first message is unidentifiable.

According to one or more embodiments of this aspect, the processing circuitry is further configured to determine at least one PDC measurement during a periodic reporting period for PDC measurements is not reportable, the second message being based on the determination.

According to one or more embodiments of this aspect, at least one of the first message and second message is communicated using wireless-device-associated signaling.

According to one or more embodiments of this aspect, at least one of the first message and second message is a F1AP procedure.

According to one or more embodiments of this aspect, the second message indicates a reason for the failure.

According to one or more embodiments of this aspect, the first message includes a RAN wireless device PDC Measurement ID; and the processing circuitry is further configured to differentiate parallel procedures on-going over F1AP for a PDC measurement based at least on the RAN wireless device PDC ID.

According to one or more embodiments of this aspect, the processing circuitry is further configured to indicate an acceptable periodicity.

According to one aspect of the present disclosure, a method implemented in a DU associated with a network node that is configured to communicate with a wireless device is provided. The method includes receiving a first message from a CU associated with the network node, the first message requesting for the DU to at least one of pause and terminate at least one on-going PDC measurement. The method includes transmitting a second message to the CU, the second message indicating failure of at least one PDC measurement during a periodic reporting period for PDC measurements.

According to one or more embodiments of this aspect, the method further includes at least one of pausing and terminating the at least one on-going PDC measurement and releasing at least one resource allocated to the at least one on-going PDC measurement based on the first message.

According to one or more embodiments of this aspect, the method further includes attempting to identify the at least one on-going PDC measurement; and ignoring the first message if the at least one on-going PDC measurement indicated in the first message is unidentifiable.

According to one or more embodiments of this aspect, the method further includes determining at least one PDC measurement during a periodic reporting period for PDC measurements is not reportable, the second message being based on the determination.

According to one or more embodiments of this aspect, at least one of the first message and second message is communicated using wireless-device-associated signaling.

According to one or more embodiments of this aspect, at least one of the first message and second message is a F1 application protocol, F1AP, procedure.

According to one or more embodiments of this aspect, the second message indicates a reason for the failure.

According to one or more embodiments of this aspect, the first message includes a RAN wireless device PDC Measurement ID; and the method further includes differentiating parallel procedures on-going over F1AP for a PDC measurement based at least on the RAN wireless device PDC ID.

According to one or more embodiments of this aspect, the method further includes indicating an acceptable periodicity.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a split architecture;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a CU associated with a network node according to some embodiments of the present disclosure;

FIG. 9 is a flowchart of an example process in a DU associated with a network node according to some embodiments of the present disclosure;

FIG. 10 is a flowchart of an example process in a CU associated with a network node according to some embodiments of the present disclosure; and

FIG. 11 is a flowchart of an example process in a DU associated with a network node according to some embodiments of the present disclosure.

### DETAILED DESCRIPTION

As discussed above, when the service is released, due to, e.g., QoS flow release, the wireless device may still have other services, i.e., the connection is still kept. gNB-CU (i.e., CU associated with the network node) does not have way solutions to inform gNB-DU (i.e., CU associated with the network node) to stop the related PDC measurements in order to liberate radio resources.

This problem is related with the case when periodic measurements for PDC are requested. There may be no possibility for the gNB-DU to indicate CU failure in the middle of the periodical reporting.

In one example, the 5G internal reference time delivery is used to time stamp gPTP messages to achieve end-to-end time synchronization for time sensitive networking (TSN). The gPTP message is supposed to be carried in a particular QoS flow. If end-to-end time synchronization is not needed, then there is no need for 5G internal reference time delivery.

In another example, due to wireless device radio condition deterioration (e.g., wireless device moving from cell center to cell edge), the propagation delay compensation performance cannot meet the performance requirement. The gNB-CU may decide to switch from legacy TA-based PDC to Round Trip Time-based PDC (which has a better performance but more radio resource consumption). Theoretically, the timing detection error is 1/bandwidth. For legacy TA-based method, the estimation is based on PRACH which has the bandwidth of 12 PRBs, while RTT-based method can be configured with higher bandwidth of reference signals (up to 756 PRBs). One or more embodiments described herein solve at least a portion of one or more problems with existing system at least in part by providing/defining the following procedures:
A TERMINATION COMMAND or ABORT message initiated by gNB-CU to stop the already started PDC measurement at gNB-DU.
A FAILURE INDICATION message initiated by gNB-DU to indicate that the previously requested periodic PDC measurements can no longer be reported.

Before describing in detail example embodiments, it is noted that the embodiments reside primarily in combinations of apparatus components and processing steps related to functionality associated with Propagation delay compensation (PDC) measurements. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, distributed unit (DU) of the network node, central unit (CU) of the network node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide functionality associated with Propagation Delay Compensation (PDC) measurements.

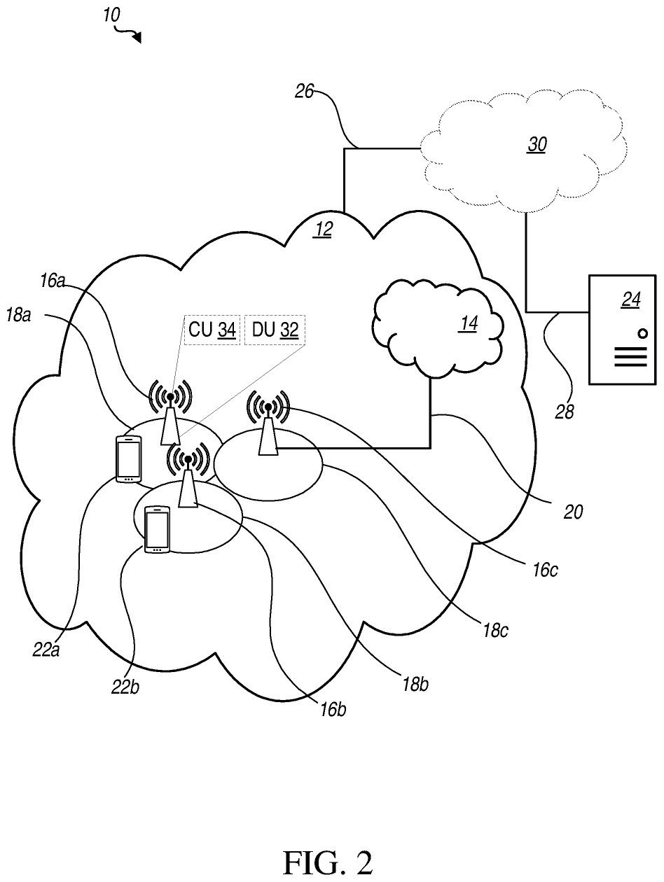

Referring now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a distributed unit (DU) 32 which is configured to perform one or more DU 32 functions as described herein. A network node 16 is configured to include a central unit (CU) 34 which is configured to perform one or more CU 34 functions as described herein. While DU 32 and CU 34 are shown as being located/provided by a single network node 16, DU 32 can be located in a separate physically and/or virtual entity from CU 34.

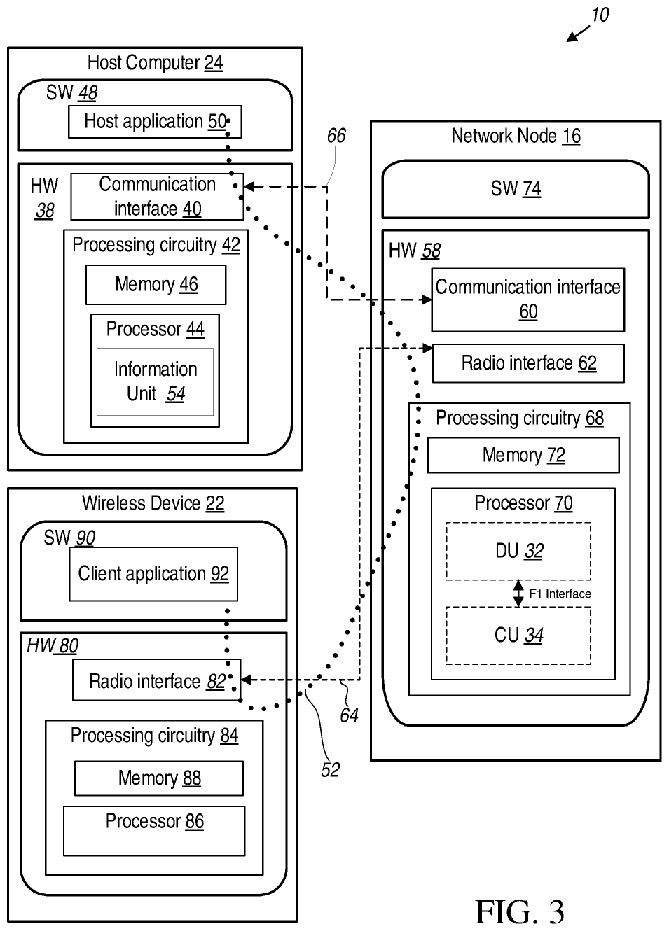

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of store, forward, receive, transmit, forward, determine, process, analyze, decode, encode, etc. signaling and/or information associated with messaging described herein.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include DU 32 (also referred to as gNB-DU) configured perform one or more DU 32 functions described herein. The processing circuitry 68 may also include CU 34 (also referred to as gNB-CU) configured to perform one or more CU 34 functions described herein.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

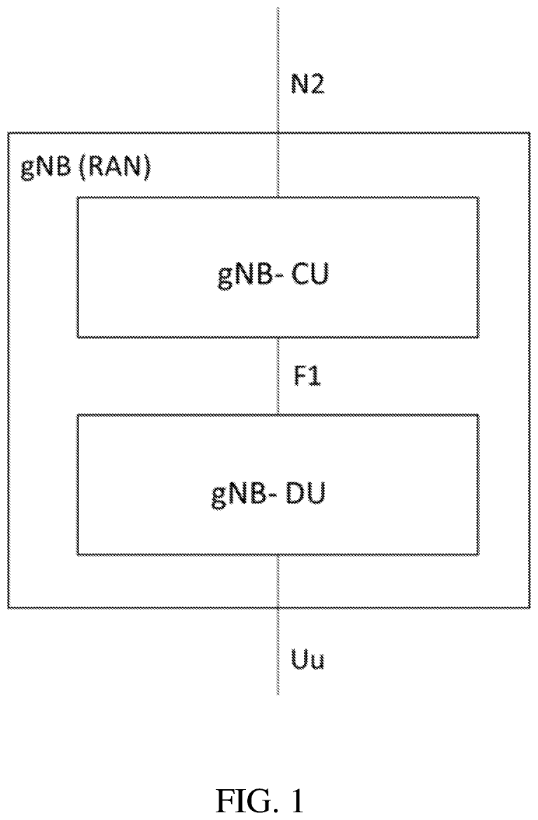

Although FIGS. 2 and 3 show various “units” such as DU 32 and CU 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. Further, DU 32 and CU 34 may have the same interfaces as illustrated in FIG. 1.

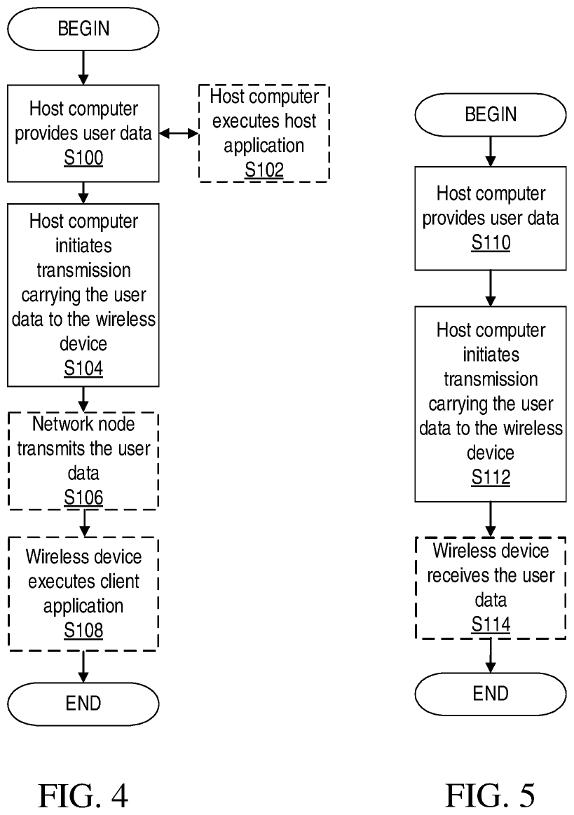

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

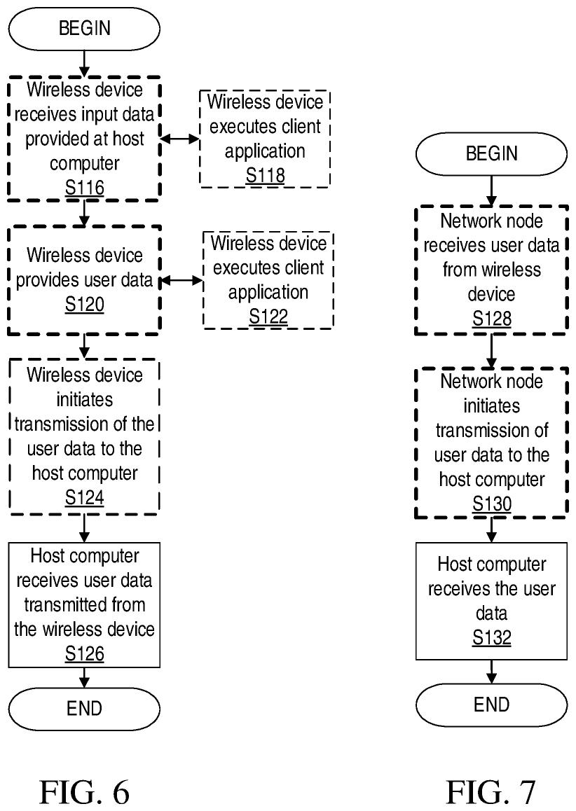

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

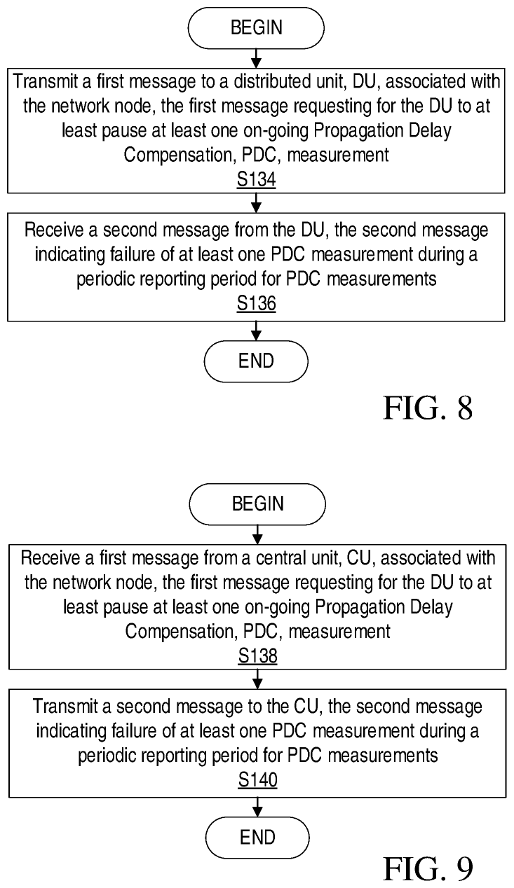

FIG. 8 is a flowchart of an example process in a CU 34 associated with a network node 16 according to some embodiments of the present disclosure. One or more blocks described herein may be performed by one or more elements of network node 16 such as by one or more of processing circuitry 68 (including the CU 34), processor 70, radio interface 62 and/or communication interface 60. CU 34 is configured to transmit (Block S134) a first message to a distributed unit, DU 32, associated with the network node 16 where the first message requests for the DU 32 to at least pause at least one on-going propagation delay compensation, PDC, measurement, as described herein. CU 34 is configured to receive (Block S136) a second message from the DU 32 where the second message indicates failure of at least one PDC measurement during a periodic reporting period for PDC measurements, as described herein. In one or more embodiments, CU 34 is configured to perform at least one of Block S134 and Block S136.

According to one or more embodiments, at least one of the first message and second message is communicated using wireless device-associated signaling. According to one or more embodiments, at least one of the first message and second message is a class 2 F1 procedure. According to one or more embodiments, the first message includes a Radio Access Network, RAN, wireless device PDC Measurement identifier, ID, to allow the DU 32 to differentiate parallel procedures on-going over F1 for a PDC measurement. According to one or more embodiments, the second message indicates a reason for the failure.

According to one or more embodiments, the processing circuitry 68 is further configured to determine the at least one on-going PDC measurement has been at least paused by the DU 32 based on the second message. According to one or more embodiments, at least pause at least one on-going PDC measurement corresponds to one of terminate and stop at least one on-going PDC measurement. According to one or more embodiments, the processing circuitry 68 is further configured to de-configure network node pre-compensation of propagation delay.

FIG. 9 is a flowchart of an example process in a DU associated with network node 16 according to some embodiments of the present disclosure. One or more blocks described herein may be performed by one or more elements of network node 16 such as by one or more of processing circuitry 68 (including the DU 32), processor 70, radio interface 62 and/or communication interface 60. DU 32 is configured to receive (Block S138) a first message from a central unit, CU 34, associated with the network node 16 where the first message requests for the DU 32 to at least pause at least one on-going Propagation Delay Compensation, PDC, measurement, as described herein. DU 32 is configured to transmit (Block S140) a second message to the CU 34 where the second message indicates failure of at least one PDC measurement during a periodic reporting period for PDC measurements. In one or more embodiments, DU 32 is configured to perform at least one of Block S138 and Block S140.

According to one or more embodiments, the processing circuitry 68 is further configured to at least pause the at least one on-going PDC measurement and release at least one resource allocated to the at least one on-going PDC measurement based on the first message. According to one or more embodiments, the processing circuitry 68 is further configured to: attempt to identify the at least one on-going PDC measurement, and ignore the first message if the at least one on-going PDC measurement indicated in the first message is unidentifiable. According to one or more embodiments, the processing circuitry 68 is further configured to determine at least one PDC measurement during a periodic reporting period for PDC measurements is not reportable where the second message is based on the determination.

According to one or more embodiments, at least one of the first message and second message is communicated using wireless device-associated signaling. According to one or more embodiments, at least one of the first message and second message is a class 2 F1 procedure. According to one or more embodiments, the second message indicates a reason for the failure. According to one or more embodiments, the first message includes a Radio Access Network, RAN, wireless device PDC Measurement identifier, ID, and the processing circuitry 68 is further configured to differentiate parallel procedures on-going over F1 for a PDC measurement based at least on the RAN wireless device PDC ID. According to one or more embodiments, at least pause at least one on-going PDC measurement corresponds to one of terminate and stop at least one on-going PDC measurement. According to one or more embodiments, the processing circuitry 68 is further configured to indicate an acceptable periodicity.

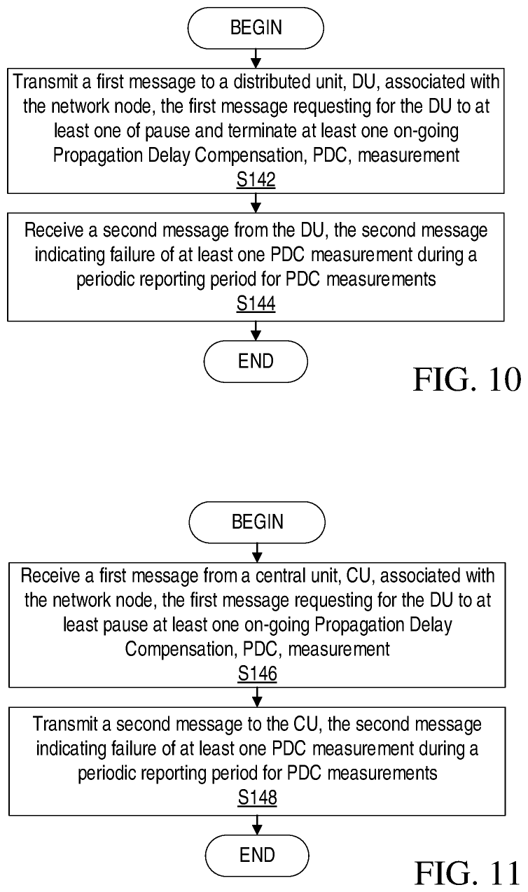

FIG. 10 is a flowchart of an example process in a CU 34 associated with a network node 16 according to some embodiments of the present disclosure. One or more blocks described herein may be performed by one or more elements of network node 16 such as by one or more of processing circuitry 68 (including the CU 34), processor 70, radio interface 62 and/or communication interface 60. CU 34 is configured to transmit (Block S142) a first message to a distributed unit, DU 32, associated with the network node 16 where the first message requests for the DU 32 to at least one of pause and terminate one on-going propagation delay compensation, PDC, measurement, as described herein. CU 34 is configured to receive (Block S144) a second message from the DU 32 where the second message indicates failure of at least one PDC measurement during a periodic reporting period for PDC measurements, as described herein. In one or more embodiments, CU 34 is configured to perform at least one of Block S134 and Block S136.

According to one or more embodiments, at least one of the first message and second message is communicated using wireless-device-associated signaling.

According to one or more embodiments, at least one of the first message and second message is a F1 application protocol, F1AP, procedure.

According to one or more embodiments, the first message includes a Radio Access Network, RAN, wireless device PDC Measurement identifier, ID, to allow the DU 32 to differentiate parallel procedures on-going over F1AP for a PDC measurement.

According to one or more embodiments, the second message indicates a reason for the failure.

According to one or more embodiments, the CU 42, such as via the processing circuitry 68, is further configured to determine whether the at least one on-going PDC measurement has been at least one of paused and terminated by the DU 32 based on the second message.

According to one or more embodiments, the CU 42, such as via the processing circuitry 68, is further configured to trigger the DU 32 to release resources the DU 32 has allocated for the at least one on-going PDC measurement.

FIG. 11 is a flowchart of an example process in a DU associated with network node 16 according to some embodiments of the present disclosure. One or more blocks described herein may be performed by one or more elements of network node 16 such as by one or more of processing circuitry 68 (including the DU 32), processor 70, radio interface 62 and/or communication interface 60. DU 32 is configured to receive (Block S146) a first message from a central unit, CU 34, associated with the network node 16 where the first message requests for the DU 32 to at least one of pause and terminate at least one on-going Propagation Delay Compensation, PDC, measurement, as described herein. DU 32 is configured to transmit (Block S148) a second message to the CU 34 where the second message indicates failure of at least one PDC measurement during a periodic reporting period for PDC measurements. In one or more embodiments, DU 32 is configured to perform at least one of Block S138 and Block S140.

According to one or more embodiments, the DU 32, such as via the processing circuitry 68, is further configured to at least one of pause and terminate the at least one on-going PDC measurement and release at least one resource allocated to the at least one on-going PDC measurement based on the first message.

According to one or more embodiments, the DU 32, such as via the processing circuitry 68, is further configured to: attempt to identify the at least one on-going PDC measurement; and ignore the first message if the at least one on-going PDC measurement indicated in the first message is unidentifiable.

According to one or more embodiments, the DU 32, such as via the processing circuitry 68, is further configured to determine at least one PDC measurement during a periodic reporting period for PDC measurements is not reportable, the second message being based on the determination.

According to one or more embodiments, at least one of the first message and second message is communicated using wireless-device-associated signaling.

According to one or more embodiments, at least one of the first message and second message is a F1 application protocol, F1AP, procedure.

According to one or more embodiments, the second message indicates a reason for the failure.

According to one or more embodiments, the first message includes a Radio Access Network, RAN, wireless device PDC Measurement identifier, ID; and the DU 32, such as via the processing circuitry 68, is further configured to differentiate parallel procedures on-going over F1AP for a PDC measurement based at least on the RAN wireless device PDC ID.

According to one or more embodiments, the DU 32, such as via the processing circuitry 68, is further configured to indicate an acceptable periodicity.

Having described the general process flow of arrangements of the disclosure and having provided examples of hardware and software arrangements for implementing the processes and functions of the disclosure, the sections below provide details and examples of arrangements associated functionality associated with Propagation Delay Compensation (PDC) measurements.

Some embodiments provide for various functionality associated with PDC measurements. One or more DU 32 (e.g., gNB-DU) functions described below may be performed by one or more of processing circuitry 68, processor 70, DU 32, etc. One or more CU 34 (e.g., gNB-CU) functions described below may be performed by one or more of processing circuitry 68, processor 70, CU 34, etc.

### Embodiments for ABORT Message

1. One or more methods for gNB-CU comprising:
a. Sending a message to the gNB-DU requesting to abort/stop/terminate an on-going PDC measurement.
b. The new message uses wireless-device-associated signaling and is class 2 F1 procedure that may be named PDC MEASUREMENT ABORT message or PDC MEASUREMENT TERMINATION COMMAND message. The new message requests to, for example, abort, stop or terminate an on-going PDC measurement.
c. Including a RAN wireless device PDC Measurement ID to distinguish of parallel procedures on-going over F1 for the same measurement
d. After performing the method a above, the gNB-CU may further de-configure gNB pre-compensation of propagation delay compensation. For example, the gNB has configured ta-PDC-r17 to be deactivate in the RRC message DLInformationTransfer to indicate gNB-side pre-compensation. After performing the method a, gNB may de-configure this value, e.g., by configuring ta-PDC-r17 to activate, or releasing this field and configuring RTT-based method, or simply releasing this field and etc. An example of the DL information IE is provided below:

DLInformationTransfer-v1700-IEs ::= SEQUENCE {

| | | |
|---|---|---|
| dedicatedInfoF1c-r17 | DedicatedInfoF1c-r17 | OPTIONAL, - |

- Need N

| | | |
|---|---|---|
| rxTxTimeDiff-gNB-r17 | RxTxTimeDiff-r17 | OPTIONAL, |

-- Need R

| | |
|---|---|
| ta-PDC-r17 | ENUMERATED {activate,deactivate} |

OPTIONAL, -- Need R

| | | |
|---|---|---|
| sib9Fallback-r17 | ENUMERATED {true} | OPTIONAL, |

-- Need R

| | | |
|---|---|---|
| nonCriticalExtension | SEQUENCE { } | OPTIONAL |

}

An example of F1AP signaling is provided below:

### PDC Measurement Abort

This message is sent by the gNB-CU to request the gNB-DU to abort/terminate a PDC measurement.

Direction: gNB-CU to gNB-DU.

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | ignore |
| gNB-CU UE | M | 9.3.1.4 | YES | reject |
| F1AP ID | | | | |
| gNB-DU UE | M | 9.3.1.5 | YES | reject |
| F1AP ID | | | | |
| RAN UE | M | INTEGER | YES | reject |
| PDC Measurement | | (1 . . . 16, . . . ) | | |
| ID | | | | |

e. In one embodiment, the gNB-DU may terminate the on-going PDC measurement and may release any resources previously allocated for the same measurement.
f. In one embodiment, if the gNB-DU cannot identify the previously requested measurement to be aborted, the gNB-DU may ignore the PDC MEASUREMENT ABORT message.
g. In one embodiment, only a periodic PDC measurement can be aborted.

### Embodiments for FAILURE INDICATION Message

2. One or more methods for gNB-DU comprising:
a. Realizing/determining that during a requested periodic reporting for PDC measurements, the measurements can no longer be reported to gNB-CU.
b. Sending a message to the gNB-CU with the indication of failure of the periodic PDC measurement. This indication means that the previously requested PDC measurements can no longer be reported.
c. The message uses wireless-device-associated signaling and is class 2 F1 procedure named PDC MEASUREMENT FAILURE INDICATION message.
d. Including a RAN wireless device PDC Measurement ID to distinguish of parallel procedures on-going over F1 for the same measurement.
e. Including a cause value indicating the reason of failure.

An example of the signaling is provided below:

### 9.2.12.Y PDC Measurement Failure Indication

This message is sent by the gNB-DU to indicate that the previously requested PDC measurements can no longer be reported.

Direction: gNB-DU to gNB-CU.

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message Type | M | 9.3.1.1 | YES | ignore |
| gNB-CU UE | M | 9.3.1.4 | YES | reject |
| F1AP ID | | | | |
| gNB-DU UE | M | 9.3.1.5 | YES | reject |
| F1AP ID | | | | |
| RAN UE | M | INTEGER | YES | reject |
| PDC Measurement | | (1 . . . 16, . . . ) | | |
| ID | | | | |
| Cause | M | 9.3.1.2 | YES | ignore |

f. In one embodiment, upon reception of the PDC MEASUREMENT FAILURE INDICATION message, the gNB-CU may consider that the indicated PDC measurements have been terminated by the gNB-DU.
g. In one embodiment, a new cause is added in the “IE Cause” in 9.3.1.2. The new cause is that the radio resource is temporarily overloaded at the gNB-DU.
   i. In this case, the gNB-DU may further indicate an acceptable periodicity. This acceptable periodicity is the smallest periodicity that the gNB-DU can allocate sufficient radio resources for TA measurement. This is to facilitate gNB-CU to send an updated request that can be successfully initiated at the gNB-DU.

| | | | | |
|---|---|---|---|---|
| Acceptable PDC | O | ENUMERATED | YES | ignore |
| Measurement | | (120 ms, 240 ms, | | |
| Periodicity | | 480 ms, 640 ms, | | |
| | | 1024 ms, 2048 ms, | | |
| | | 5120 ms, 10240 ms, | | |
| | | 20480 ms, | | |
| | | 40960 ms, 1 min, | | |
| | | 6 min, 12 min, , . . . ) | | |

Accordingly, one or more embodiments described herein provides one or more of the following advantages:
The gNB-CU can abort or force to terminate on-going measurement for PDC due to, for example, release of service (i.e. release of QoS flow) and liberate resources at gNB-DU.
The gNB-DU can indicate, in case of, for examples, periodic measurement reporting for TA-PDC that the resources can no longer be reported due to shortage of resources, radio condition changes, or other causes.

### Some Examples

Example A1. A central unit, CU, 34 associated with a network node that is configured to communicate with a wireless device, the CU 34 configured to, and/or comprising a radio interface and/or comprising processing circuitry configured to at least one of:
transmit a first message to a distributed unit, DU, 32 associated with the network node, the first message requesting for the DU 32 to at least pause at least one on-going Propagation Delay Compensation, PDC, measurement; and
receive a second message from the DU, 32 the second message indicating failure of at least one PDC measurement during a periodic reporting period for PDC measurements.

Example A2. The CU 34 of Example A1, wherein at least one of the first message and second message is communicated using wireless device-associated signaling.

Example A3. The CU 34 of any one of Examples A1-A2, wherein at least one of the first message and second message is a class 2 F1 procedure.

Example A4. The CU 34 of any one of Examples A1-A3, wherein the first message includes a Radio Access Network, RAN, wireless device PDC Measurement identifier, ID, to allow the DU 32 to differentiate parallel procedures on-going over F1 for a PDC measurement.

Example A5. The CU 34 of any one of Examples A1-A4, wherein the second message indicates a reason for the failure.

Example A6. The CU 34 of any one of Examples A1-A5, wherein the processing circuitry is further configured to determine the at least one on-going PDC measurement has been at least paused by the DU based on the second message.

Example A7. The CU 34 of any one of Examples A1-A6, wherein at least pause at least one on-going PDC measurement corresponds to one of terminate and stop at least one on-going PDC measurement.

Example A8. The CU 34 of any one of Examples A1-A7, wherein the processing circuitry is further configured to de-configure network node pre-compensation of propagation delay.

Example B1. A method implemented by a central unit, CU, 34 associated with a network node that is configured to communicate with a wireless device, the method comprising:
transmitting a first message to a distributed unit, DU, 32 associated with the network node, the first message requesting for the DU 32 to at least pause at least one on-going Propagation Delay Compensation, PDC, measurement; and
receiving a second message from the DU, 32 the second message indicating failure of at least one PDC measurement during a periodic reporting period for PDC measurements.

Example B2. The method of Example B1, wherein at least one of the first message and second message is communicated using wireless device-associated signaling.

Example B3. The method of any one of Examples B1-B2, wherein at least one of the first message and second message is a class 2 F1 procedure.

Example B4. The method of any one of Examples B1-B3, wherein the first message includes a Radio Access Network, RAN, wireless device PDC Measurement identifier, ID, to allow the DU 32 to differentiate parallel procedures on-going over F1 for a PDC measurement.

Example B5. The method of any one of Examples B1-B4, wherein the second message indicates a reason for the failure.

Example B6. The method of any one of Examples B1-B5, further comprising determining the at least one on-going PDC measurement has been at least paused by the DU 32 based on the second message.

Example B7. The method of any one of Examples B1-B6, wherein at least pause at least one on-going PDC measurement corresponds to one of terminate and stop at least one on-going PDC measurement.

Example B8. The method of any one of Examples B1-B7, further comprising de-configuring network node pre-compensation of propagation delay.

Example C1. A distributed unit, DU, 32 associated with network node that is configured to communicate with a wireless device, the DU 32 configured to, and/or comprising a radio interface and/or comprising processing circuitry configured to:
receive a first message from a central unit, CU, 34 associated with the network node, the first message requesting for the DU 32 to at least pause at least one on-going Propagation Delay Compensation, PDC, measurement; and
transmit a second message to the CU 34, the second message indicating failure of at least one PDC measurement during a periodic reporting period for PDC measurements.

Example C2. The DU 32 of Example C1, wherein the processing circuitry is further configured to at least pause the at least one on-going PDC measurement and release at least one resource allocated to the at least one on-going PDC measurement based on the first message.

Example C3. The DU 32 of any one of Examples C1-C2, wherein the processing circuitry is further configured to:
attempt to identify the at least one on-going PDC measurement; and
ignore the first message if the at least one on-going PDC measurement indicated in the first message is unidentifiable.

Example C4. The DU 32 of any one of Examples C1-C3, wherein the processing circuitry is further configured to:
determine at least one PDC measurement during a periodic reporting period for PDC measurements is not reportable, the second message being based on the determination.

Example C5. The DU 32 of any one of Examples C1-C4, wherein at least one of the first message and second message is communicated using wireless device-associated signaling.

Example C6. The DU 32 of any one of Examples C1-C5, wherein at least one of the first message and second message is a class 2 F1 procedure.

Example C7. The DU 32 of any one of Examples C1-C6, wherein the second message indicates a reason for the failure.

Example C8. The DU 32 of any one of Examples C1-C7, wherein the first message includes a Radio Access Network, RAN, wireless device PDC Measurement identifier, ID; and
the processing circuitry being further configured to differentiate parallel procedures on-going over F1 for a PDC measurement based at least on the RAN wireless device PDC ID.

Example C9. The DU 32 of any one of Examples C1-C8, wherein at least pause at least one on-going PDC measurement corresponds to one of terminate and stop at least one on-going PDC measurement.

Example C10. The DU 32 of any one of Examples C1-C9, wherein the processing circuitry is further configured to indicate an acceptable periodicity.

Example D1. A method implemented by a distributed unit, DU, 32 associated with network node that is configured to communicate with a wireless device, the method comprising:
receiving a first message from a central unit, CU, 34 associated with the network node, the first message requesting for the DU 32 to at least pause at least one on-going Propagation Delay Compensation, PDC, measurement; and
transmitting a second message to the CU 34, the second message indicating failure of at least one PDC measurement during a periodic reporting period for PDC measurements.

Example D2. The method of Example D1, wherein the processing circuitry is further configured to at least pause the at least one on-going PDC measurement and release at least one resource allocated to the at least one on-going PDC measurement based on the first message.

Example D3. The method of any one of Examples D1-D2, wherein the processing circuitry is further configured to:
attempt to identify the at least one on-going PDC measurement; and
ignore the first message if the at least one on-going PDC measurement indicated in the first message is unidentifiable.

Example D4. The method of any one of Examples D1-D3, wherein the processing circuitry is further configured to:
determine at least one PDC measurement during a periodic reporting period for PDC measurements is not reportable, the second message being based on the determination.

Example D5. The method of any one of Examples D1-D4, wherein at least one of the first message and second message is communicated using wireless device-associated signaling.

Example D6. The method of any one of Examples D1-D5, wherein at least one of the first message and second message is a class 2 F1 procedure.

Example D7. The method of any one of Examples D1-D6, wherein the second message indicates a reason for the failure.

Example D8. The method of any one of Examples D1-D7, wherein the first message includes a Radio Access Network, RAN, wireless device PDC Measurement identifier, ID; and
the processing circuitry being further configured to differentiate parallel procedures on-going over F1 for a PDC measurement based at least on the RAN wireless device PDC ID.

Example D9. The method of any one of Examples D1-D8, wherein at least pause at least one on-going PDC measurement corresponds to one of terminate and stop at least one on-going PDC measurement.

Example D10. The method of any one of Examples D1-D9, further comprising indicating an acceptable periodicity.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A central unit, CU, associated with a network node that is configured to communicate with a wireless device, the CU comprising:
processing circuitry configured to:
transmit a first message to a distributed unit, DU, associated with the network node, the first message requesting for the DU to at least one of pause and terminate at least one on-going Propagation Delay Compensation, PDC, measurement; and
receive a second message from the DU, the second message indicating failure of at least one PDC measurement during a periodic reporting period for PDC measurements.

2. (canceled)

3. (canceled)

4. The CU of claim 1, wherein the first message includes a Radio Access Network, RAN, wireless device PDC Measurement identifier, ID, to allow the DU to differentiate parallel procedures on-going over F1AP for a PDC measurement.

5. (canceled)

6. The CU of claim 1, wherein the processing circuitry is further configured to determine whether the at least one on-going PDC measurement has been at least one of paused and terminated by the DU based on the second message.

7. The CU of claim 1, wherein the processing circuitry is further configured to trigger the DU to release resources the DU has allocated for the at least one on-going PDC measurement.

8. A method implemented in a central unit, CU, associated with a network node that is configured to communicate with a wireless device, the method comprising:
transmitting a first message to a distributed unit, DU, associated with the network node, the first message requesting for the DU to at least one of pause and terminate at least one on-going Propagation Delay Compensation, PDC, measurement; and
receiving a second message from the DU, the second message indicating failure of at least one PDC measurement during a periodic reporting period for PDC measurements.

9. The method of claim 8, wherein at least one of the first message and second message is communicated using wireless-device-associated signaling.

10. The method of claim 8, wherein at least one of the first message and second message is a F1 application protocol, F1AP, procedure.

11. The method of claim 8, wherein the first message includes a Radio Access Network, RAN, wireless device PDC Measurement identifier, ID, to allow the DU to differentiate parallel procedures on-going over F1AP for a PDC measurement.

12. The method of claim 8, wherein the second message indicates a reason for the failure.

13. The method of claim 8, further comprising determining whether the at least one on-going PDC measurement has been at least one of paused and terminated by the DU based on the second message.

14. The method of claim 8, further comprising triggering the DU to release resources the DU has allocated for the at least one on-going PDC measurement.

15. A distributed unit, DU, associated with a network node that is configured to communicate with a wireless device, the DU comprising:
processing circuitry configured to:
receive a first message from a central unit, CU, associated with the network node, the first message requesting for the DU to at least one of pause and terminate at least one on-going Propagation Delay Compensation, PDC, measurement; and
transmit a second message to the CU, the second message indicating failure of at least one PDC measurement during a periodic reporting period for PDC measurements.

16. The DU of claim 15, wherein the processing circuitry is further configured to at least one of pause and terminate the at least one on-going PDC measurement and release at least one resource allocated to the at least one on-going PDC measurement based on the first message.

17. The DU of claim 15, wherein the processing circuitry is further configured to:
attempt to identify the at least one on-going PDC measurement; and
ignore the first message if the at least one on-going PDC measurement indicated in the first message is unidentifiable.

18. The DU of claim 15, wherein the processing circuitry is further configured to:
determine at least one PDC measurement during a periodic reporting period for PDC measurements is not reportable, the second message being based on the determination.

19. (canceled)

20. (canceled)

21. (canceled)

22. The DU of claim 15, wherein the first message includes a Radio Access Network, RAN, wireless device PDC Measurement identifier, ID; and
the processing circuitry being further configured to differentiate parallel procedures on-going over F1AP for a PDC measurement based at least on the RAN wireless device PDC ID.

23. The DU of claim 15, wherein the processing circuitry is further configured to indicate an acceptable periodicity.

24. A method implemented in a distributed unit, DU, associated with a network node that is configured to communicate with a wireless device, the method comprising:
receiving a first message from a central unit, CU, associated with the network node, the first message requesting for the DU to at least one of pause and terminate at least one on-going Propagation Delay Compensation, PDC, measurement; and
transmitting a second message to the CU, the second message indicating failure of at least one PDC measurement during a periodic reporting period for PDC measurements.

25. The method of claim 24, further comprising at least one of pausing and terminating the at least one on-going PDC measurement and releasing at least one resource allocated to the at least one on-going PDC measurement based on the first message.

26. The method of claim 24, further comprising:
attempting to identify the at least one on-going PDC measurement; and
ignoring the first message if the at least one on-going PDC measurement indicated in the first message is unidentifiable.

27. The method of claim 24, further comprising:
determining at least one PDC measurement during a periodic reporting period for PDC measurements is not reportable, the second message being based on the determination.

28. The method of claim 24, wherein at least one of the first message and second message is communicated using wireless-device-associated signaling.

29. The method of claim 24, wherein at least one of the first message and second message is a F1 application protocol, F1AP, procedure.

30. The method of claim 24, wherein the second message indicates a reason for the failure.

31. The method of claim 24, wherein the first message includes a Radio Access Network, RAN, wireless device PDC Measurement identifier, ID; and
the method further comprises differentiating parallel procedures on-going over F1AP for a PDC measurement based at least on the RAN wireless device PDC ID.

32. The method of claim 24, further comprising indicating an acceptable periodicity.
